(19) United States
(12) Patent Application Publication
(10) Pub. No.: US 2007/0018427 A1
(43) Pub. Date: Jan. 25, 2007

(54) Motorcycle strut assembly

(76) Inventor: Joseph DeLellis, Sparta, NJ (US)

Correspondence Address: HOFFMANN & BARON, LLP, 6900 JERICHO TURNPIKE, SYOSSET, NY, 11791, US

(21) Appl. No.: 11/489,105

(22) Filed: Jul. 19, 2006

Related U.S. Application Data
(60) Provisional application No. 60/700,394, filed on Jul. 19, 2005.

(51) Int. Cl. B62J 27/00

(52) U.S. Cl. 280/304.3

(57) ABSTRACT

A strut assembly for a motorcycle includes an elongate strut member having opposed upper and lower ends; a first mounting device for securing the upper end of the strut assembly to a portion of an handle bar of a motorcycle; and a second mounting device for securing the lower end of the strut assembly to a portion of a front end of the motorcycle, wherein the second mounting device includes an end that is rotatable and pivotable and the lower end of the strut assembly is slidably engaged through the rotatable and pivotable end of the second mounting bracket. Desirably, the second mounting device is a swivel bolt. The elongate strut assembly may a series of securably joined links of a chain, in the shape of an elongate shield, in the shape of a sword, or any other suitable elongate and rigid configuration or design.

### CROSS-REFERENCE TO RELATED APPLICATIONS

This application claims the benefit of U.S. Provisional Application No. 60/700,394, filed Jul. 19, 2005, the contents of which are incorporated herein by reference.

### FIELD OF INVENTION

The present invention is directed to a strut assembly for the front end of a vehicle. More particularly, the present invention is a motorcycle strut assembly for the front end thereof.

### BACKGROUND OF THE OF INVENTION

The front end of a motorcycle is subject to stresses during use. For example, when the motorcycle is being turned, the front end is subjected to rotational stresses. Further, when the motor cycle is traveling over bumpy roads or terrain, the front end is subjected to axial stresses. Accordingly, a front end strut assembly for a motorcycle has not been proposed because of the difficulty in overcoming the problems associated with such front end stresses.

Thus, there is a need in the art for a motor strut assembly that can withstand the stresses associated with motorcycle usage while not adversely affecting the performance of the motorcycle.

### SUMMARY OF INVENTION

In one aspect of the present invention, a strut assembly for a motorcycle includes an elongate strut member having opposed upper and lower ends; a first mounting device for securing the upper end of the strut assembly to a portion of an handle bar of a motorcycle; and a second mounting device for securing the lower end of the strut assembly to a portion of a front end of the motorcycle, wherein the second mounting device includes an end that is rotatable and pivotable and the lower end of the strut assembly is slidably engaged through the rotatable and pivotable end of the second mounting bracket. Desirably, the second mounting device is a swivel bolt. The elongate strut assembly may a series of securably joined links of a chain, in the shape of an elongate shield, in the shape of a sword, or any other suitable elongate and rigid configuration or design. The elongate strut member may be a metallic member, for example, a chrome-plated member.

In another aspect of the present invention, a strut assembly for a motorcycle includes an elongate strut member having opposed upper and lower ends; a first mounting device for securing the upper end of the strut assembly to a portion of an upper portion of a motorcycle; and a second mounting device for securing the lower end of the strut assembly to a lower portion of the motorcycle, wherein the second mounting device comprises an end that is rotatable and pivotable and the lower end of the strut assembly is slidable engaged through the rotatable and pivotable end of the second mounting bracket. The lower portion of the motor cycle may be a front end of the motor cycle, a rear end of the motor cycle, a front axle of the motor cycle, a rear axle of the motor cycle or combinations thereof. The upper portion of the motor cycle may be a handle bar of the motor cycle, a rear upper frame of the motor cycle, a front upper frame of the motor cycle, a seat portion of the motor cycle, a seat support portion of the motor cycle or combinations thereof.

### BRIEF DESCRIPTION OF THE DRAWINGS

FIG. 1 is a side elevational view of a motorcycle.

FIG. 2 is a front elevational view of one embodiment of a motorcycle strut assembly according to the present invention.

FIG. 3 is a front elevational view of another embodiment of a motorcycle strut assembly according to the present invention.

FIG. 4 is a front elevational view of yet another embodiment of a motorcycle strut assembly according to the present invention.

FIG. 5 is side elevation view of a first mounting bracket according to the present invention.

FIG. 6 is side elevation view of a second mounting bracket according to the present invention.

FIG. 7 is a top view of a swivel support or bolt according to the present invention.

FIG. 8 is a schematic view of a portion of the strut assembly of the present invention slidably engaged with the swivel support of FIG. 7.

FIG. 9 is a top view of a swivel support or bolt according to the present invention depicting a rotatable ball positioned within the bolt.

FIG. 10 is a top view of the ball of FIG. 9.

FIG. 11 is a top view of a swivel support or bolt according to the present invention having a pivotable and rotatable head portion.

FIG. 12 is a side elevation view of a cover for secured to the swivel support of bold of FIG. 11, according to the present invention.

FIG. 13 is a front elevations view of the cover of FIG. 12 illustrating an oval-shaped cover.

### DETAILED DESCRIPTION OF INVENTION

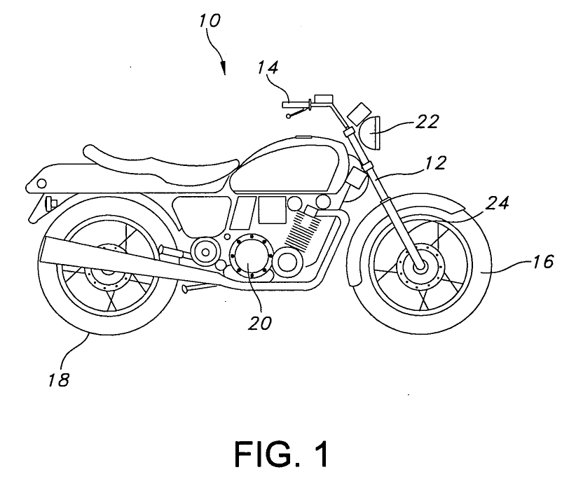

Now referring to the figures, wherein like elements are identically or similarly numbered, FIG. 1 depicts a motorcycle 10 having a front end 12, handle bars 14, front tire 16, rear tire 18 and engine 20, interrelated as shown. The motor cycle 10 further includes a front headlight 22 and a pair of front end shock absorbers or assemblies 24. The strut assemblies of the present invention, which are described below, are securable to the front end 12 and the handle bars 14 of motorcycle 10. The strut assemblies of the present invention, however, are not limited to use with just motorcycles and other vehicles having a shock-absorbing front end may suitable be fitted with the strut assemblies of the present invention. Non-limiting examples of other such suitable vehicles may include, but are not limited to, dirt bikes, snow mobiles, motorized tricycles, and the like.

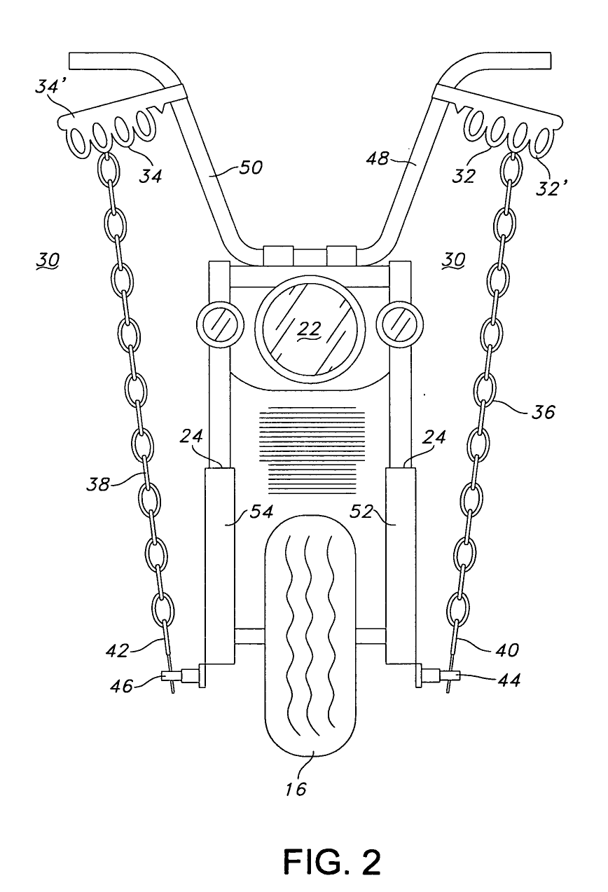

FIG. 2 depicts one embodiment of strut assembly 30 of the present invention. As depicted in FIG. 2, strut assembly 30 includes left and right handle bar mounts 32 and 34 for securing the strut assembly 30 to respective left and right handle bars 48 and 50. Descending from the left and right handle bar mounts 32 and 34 are elongate members or struts 36 and 38, respectively. The struts 36 and 38 may include lower portions 40 and 42, respectively, which are slidably securable to the left and right front end mounts 44 and 46. The left front end mounts 44 and 46 are secured to left and right front end portions 52 and 54, respectively, of the motorcycle 10.

Desirably, the strut assembly 30 is a relatively rigid, for example, a substantially rigid, assembly. While the struts 36 and 38 are depicted as chains in FIG. 2, adjacent links of the chains are desirably welded (not shown) to one and the other to provide rigidity to the struts 36 and 38. The lower portions 40 and 42 may also be welded to the bottom terminal chain of the struts 36 and 38. The present invention, however, is no so limited and the lower portions 40 and 42 may be secured to the struts 40 and 42 by other mechanical means, for example by bolting.

The left and right handle bar mounts 32 and 34 may be secured to the left and right handle bars 48 and 50 by clamping, bolting, welding, and the like. The left and right handle mounts 32 and 34 may further include handles 32′ and 34′. The handles 32′ and 34′ are useful for extending the struts 36 and 38 away from the handle bar 48 and 50. Desirably, the handles 32′ and 34′ may include a decorative design, such as brass knuckles as depicted in FIG. 2.

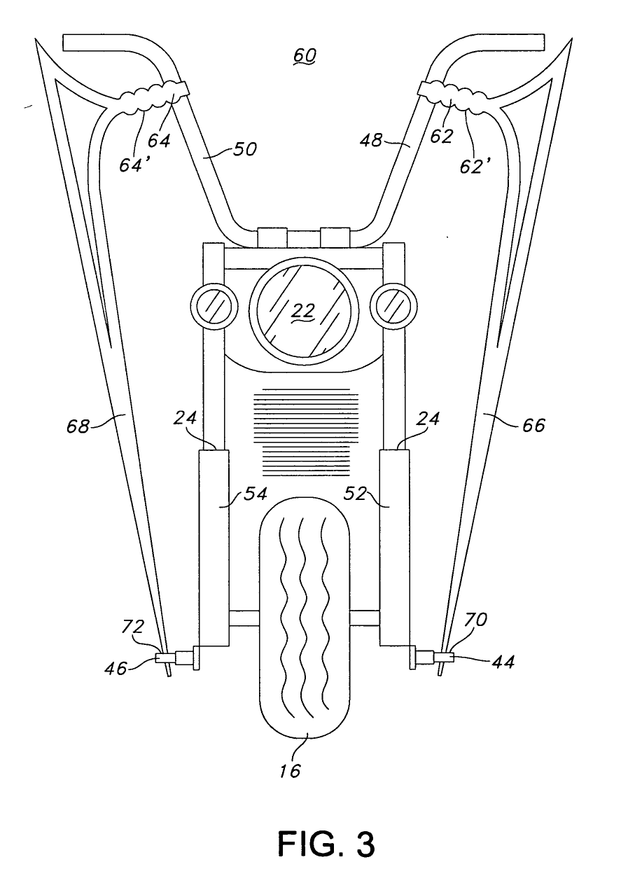

FIG. 3 depicts another embodiment of a strut assembly 60 according to the present invention. The strut assembly 60 may include left and right handle bar mounts 62 and 64 for securing the strut assembly 60 to respective left and right handle bars 48 and 50. Descending from the left and right handle bar mounts 62 and 64 are elongate members or struts 66 and 68, respectively. The struts 66 and 68 may also include lower portions 70 and 72, respectively, which are slidably securable to the left and right front end mounts 44 and 46. The left and right front end mounts 44 and 46 are secured to left and right front end portions 52 and 54, respectively. The strut assemblies 66 and 68 are also relative rigid elongate members and are depicted as being in the shape of a shield-like member. The assembly 60 may further include handles 62′ and 64′ for extending the top portion of the struts 66 and 68 away from the handle bars 48 and 50. The struts 66 and 68 may include lower portions 70 and 72 which are desirably slidably securable to the left and right front end mounts 44 and 46. The left front end mounts 44 and 46 are also securable to left and right front end portions 52 and 54, respectively.

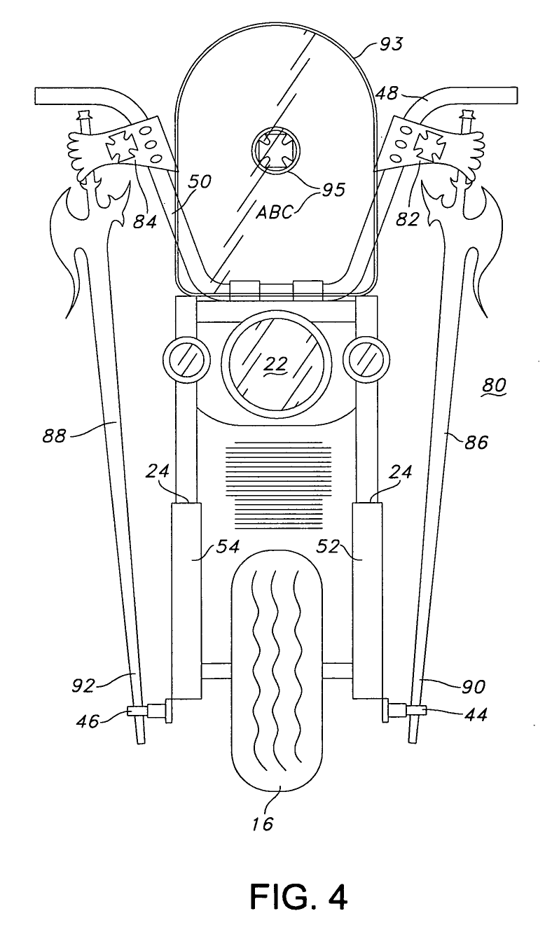

As depicted in FIG. 4, the strut assembly 80 may also be in the design of a pair of swords 86, 88. For example, left and right handle bar mounts 82 and 84 may be in the shape of hands or gloves and are useful for securing the strut assembly 80 to respective left and right handle bars 48 and 50. Descending from the left and right handle bar mounts 82 and 84 are the elongate members or struts 86 and 88, respectively, which, as depicted in FIG. 4, are in the shape of a sword. The struts 86 and 88 may also include lower portions 90 and 92 which are slidably securable to the left and right front end mounts 44 and 46. The left front end mounts 44 and 46 are securable to left and right front end portions 52 and 54, respectively.

As depicted in FIG. 4, the strut assemblies of the present invention are useful for securing banners, shields and the like 93 having depictions such as symbols and/or lettering 95, for example advertisements, club names, and the like. The strut assemblies of the present invention may also be useful for securing a deflector against snow and rain and may be further useful for securing a wind guard. The strut assemblies of the present invention may also be used to support additional lights (not shown) to provide additional safety features to a motorcycle so fitted with the inventive strut assembly.

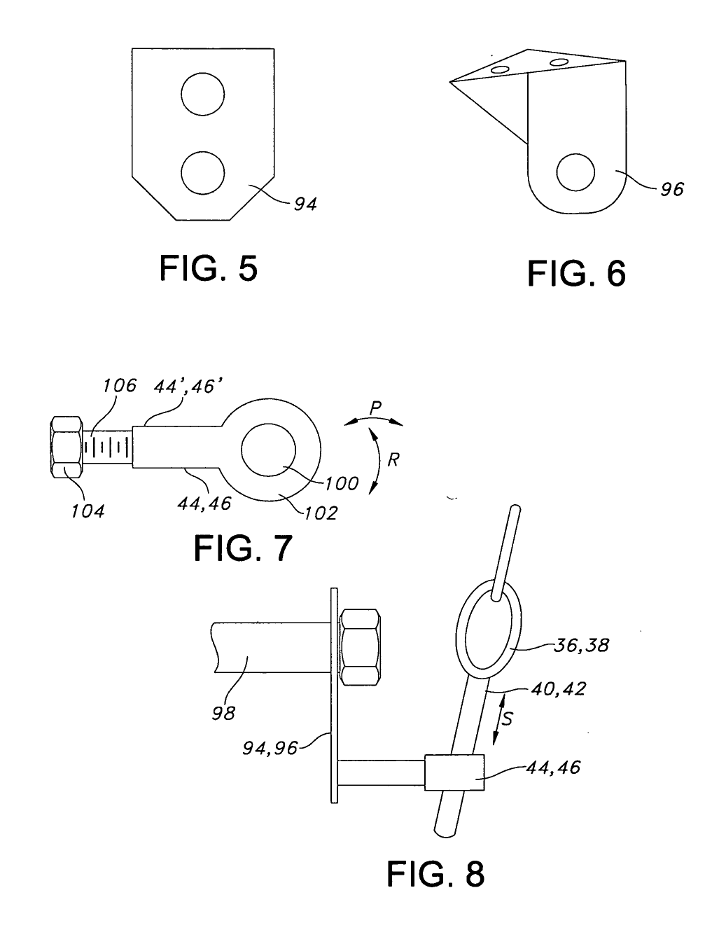

FIGS. 5 and 6 depict mounting brackets 94 and 96. The mounting brackets 94 and 96 are useful for securing the strut assemblies of the present invention to the front end portion 52 and 54.

FIG. 7 further depicts additional details of the left and right front end mounts 44 and 46 of the present invention. Desirably, the mounts 44 and 46 are swivel supports or swivel eye bolts. The swivel bolts 44 and 46 have an orifice 100 through which the lower portions 40, 42, 70, 72, 90, 92 of the struts 36, 38, 66, 68, 86, 88 may slide therethrough. Although the orifice is depicted as being circular, the present invention is no so limited and other shaped orifices, such as oval, rectangular, square, and the like, may suitably be used. The head 102 of the swivel bolt 44, 46 is desirably rotatable about the longitudinal axis of the bolt, as indicated by vector “R”. Further, it is desirable that the head 102 of the swivel bolt 44, 46 may also be pivotable about the longitudinal axis of the bolt as indicated by vector “P”. Such rotatable and pivotable movement of the swivel supports 44 and 46 are useful for securing the strut assemblies 30, 60, 80 of the present invention to the front end 52, 52 of motorcycles while not interfering with the performance or handling of the motorcycle. For example, when the handle bars 48, 50 of the motorcycle 10 are turned to steer the motorcycle 10 around a bend, the swivel bolt 44, 46 may rotate to accommodate the relative movement of the handle bars 48, 50 and the front end axis, where the mounting brackets 94 and 96 secure the swivel supports 44 and 46 to the front end axle of the motorcycle 10. The pivotable movement of the swivel head 102 is also useful for maintaining stability of the strut assembly 30, 60, 80 of the present invention and the motorcycle 10 so mounted with the inventive strut assembly 30, 60, 80 as the axial stresses or movements are placed upon the front end of the motorcycle 10, for example when traveling over bumpy roads or making sharp turns. Vertical stresses are minimized as the strut assemblies 30, 60, 80 of the present invention have portions 40, 42, 70, 72, 90, 92 slidable through the eye 100 of the swivel bolt 44, 46. The end 36, 38, 66, 68, 86, 88 of the strut 40, 42, 70, 72, 90, 92 may also contain a pin, bolt, knob or other member (not shown) to prevent the end 40, 42, 70, 72, 90, 92 of the strut 36, 38, 66, 68, 86, 88 from separating or exiting from the eye 100 of the swivel bolt 44, 46. The swivel bolt 44, 46 may be bolted to the mounting brackets 94, 96 by use of the bolt 104 over threaded portion 106 of the swivel support 44, 46. The threaded portion 106 of the swivel bolt 44, 46 may be a male threaded portion or a female threaded portion (not shown).

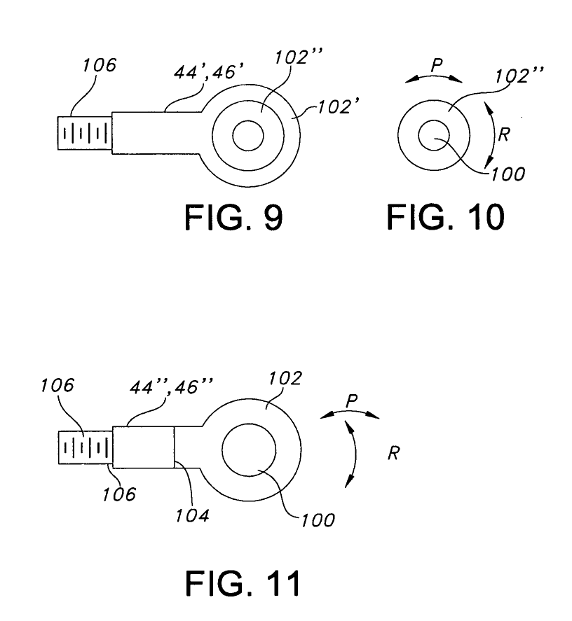

FIGS. 9-11 depict additional details of swivel bolts useful with the present invention. As depicted in FIGS. 9-10 the swivel bolts 44′, 46′ may include a ball 102″ having an orifice 100 therethrough. The ball 102″ is rotatably mounted with the head 102′ of the swivel bolt 44′, 46′, for example by a press fit with a bearing mechanism for ease of rotation of the ball 102″ within the head 102′. Such an arrangement permits both rotational (R) and pivotable (P) movement of the ball 102″ with the swivel bolt head 102′. Such a swivel bolt 44′, 46′ is commonly referred to as a rod end bearing and is commercially available from Buyers Products Co., model number 440-841-8003 for size ½×20. Another embodiment of for the swivel bolt 44″, 46″ is depicted in FIG. 11. As depicted in FIG. 11, the head 102 is rotatable and pivotable about the body (or length) 106 at arrangement 104. The arrangement 104 may be any useful design, for example a ball and socket arrangement (not shown) which allows for the desired movement of the head 102 of the eyebolt or swivel bolt 44″, 46″.

FIG. 8 depicts the lower portion 40, 42 of the strut assembly 30 being slidably engaged, as indicated by vector “S”, with the swivel support 44, 46. As depicted in FIG. 8 the lower portion 40, 42 of the strut assembly 30 is safely secured away from the axle 98 of the motorcycle.

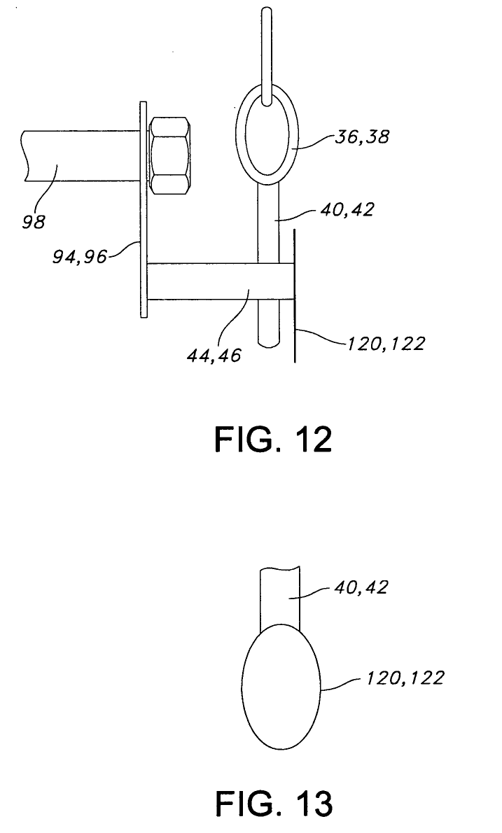

FIGS. 12-13 depict a cover 120, 122 secured to the swivel supports 44, 46, respectively. As depicted in FIG. 13, the cover 120, 122 may cover or block or overlay the lower portions 40, 42 of the strut assembly. The shape of the cover 120, 122 is depicted as being oval in FIG. 13, but the present invention is not so limited. The cover 120, 122 may be any useful shape, such as but not limited to circular, triangular, rectangular, square, multi-sided polygon and the like. Further, the cover 120, 122 may include decorative shapes, such as but not limited to shields, wings, banners and the like.

Desirably, the struts 36, 38, 66, 68, 86, 88 of the present invention are made from or may include metal or metallic portions. Steel, including stainless steel, is a useful metal, but other metals may suitably be used. The struts 36, 38, 66, 68, 86, 88 of the present invention may also be painted, plated, polished, finished and the like to provide a desired finish to the assemblies.

While the struts assemblies of the present invention have been described as being relatively rigid metallic members, the present invention is not so limited. For example, the strut assemblies may be made from other materials such as plastics, rubbers and the like. Desirably, these other materials should have sufficient strength and rigidity to withstand of the stresses associated with motorcycle usage.

Further, the strut assemblies of the present invention are not limited just to the use of swivel bolts for securing the assemblies to the front ends of motorcycles. Other connections that provide rotational and pivotable flexibility may suitably be used. For example, a middle portion of the strut 36 and 38 may include a spring (not shown) to hold the struts under tension after the top and bottom portions of the struts are securely bolted or otherwise secured to the motorcycle. The spring may compress and expand to provide for the vertical movement of the strut assembly. Further, the spring may rotatably engage the strut portion to provide for rotational movement of the strut assembly.

Further, the strut assemblies of the present invention are not limited to designs that are placeable at the front end of a motorcycle. Strut assemblies of the present invention may be secured to a rear axle or frame portion the motorcycle. Such a strut assembly may be useful as a back rest for the motorcycle, which are commonly referred to as “sissy” bars.

The invention being thus described, it will now be evident to those skilled in the art that the same may be varied in many ways. Such variations are not to be regarded as a departure from the spirit and scope of the invention and all such modifications are intended to be included within the scope of the following claims.

What is claimed is:

1. A strut assembly for a motorcycle, comprising:
an elongate strut member having opposed upper and lower ends;
a first mounting device for securing the upper end of the strut assembly to a portion of an handle bar of a motorcycle; and
a second mounting device for securing the lower end of the strut assembly to a portion of a front end of the motorcycle,
wherein the second mounting device comprises an end that is rotatable and pivotable and the lower end of the strut assembly is slidable engaged through the rotatable and pivotable end of the second mounting bracket.

2. The strut assembly of claim 1, wherein the second mounting device is a swivel bolt.

3. The strut assembly of claim 1, wherein the elongate strut assembly is a series of securably joined links of a chain.

4. The strut assembly of claim 1, wherein the elongate strut assembly is in the shape of an elongate shield.

5. The strut assembly of claim 1, wherein the elongate strut assembly is in the shape of a sword.

6. The strut assembly of claim 1, wherein the elongate strut member is a metallic member.

7. The strut assembly of claim 6, wherein the metallic member is a chrome-plated member.

8. A strut assembly for a motorcycle, comprising:
an elongate strut member having opposed upper and lower ends;
a first mounting device for securing the upper end of the strut assembly to a portion of an upper portion of a motorcycle; and
a second mounting device for securing the lower end of the strut assembly to a lower portion of the motorcycle,
wherein the second mounting device comprises an end that is rotatable and pivotable and the lower end of the strut assembly is slidable engaged through the rotatable and pivotable end of the second mounting bracket.

9. The strut assembly of clime 8, wherein the lower portion of the motor cycle is selected from the group consisting of a front end, a rear end, a front axle, a rear axle or combinations thereof.

10. The strut assembly of clime 8, wherein the upper portion of the motor cycle is selected from the group consisting of a handle bar, a rear upper frame, a front upper frame, a seat portion, a seat support portion or combinations thereof.
